(19) United States
(12) Patent Application Publication
(10) Pub. No.: US 2006/0201022 A1
(43) Pub. Date: Sep. 14, 2006

(54) In-kiln moisture measurement calibration system

(75) Inventor: Ronald Logan, Medford, OR (US)

Correspondence Address: KLARQUIST SPARKMAN, LLP, 121 SW SALMON STREET, SUITE 1600, PORTLAND, OR, 97204, US

(73) Assignee: Wagner Electronic Products, Inc.

(21) Appl. No.: 11/078,946

(22) Filed: Mar. 11, 2005

(51) Int. Cl. F26B 21/06; F26B 13/10

(52) U.S. Cl. 34/550; 34/528

(57) ABSTRACT

An in-kiln moisture measurement system using in-kiln measurement electronics to produce wood moisture content readings virtually unaffected by temperature variations. The system comprises electrodes in communication with wood in a kiln, a per kiln unit (PKU) containing signal processing circuitry, and a sending unit with a circuit comprised of redundant half-circuits that compensate for the effects of temperature variations in the electronic components. One half-circuit measures moisture content of the wood; the other half-circuit measures a reference load. Matched characteristics of the transistors in each circuit ensure that each half-circuit's readings drift at about the same rate and in the same direction when experiencing temperature changes. An automatic tuning unit can be used to automatically adjust properties of the PKU's circuitry and compensate for other capacitances in the system.

### TECHNICAL FIELD

The present application relates to in-kiln moisture measurement systems.

### BACKGROUND

Lumber is often dried in a kiln after it is milled in order to remove moisture from the wood and prepare it for use. When drying wood in a kiln, it is important to know how much moisture remains in the wood. Lumber that is not dried long enough and retains excess moisture may split or warp. Conversely, lumber that is overdried, or dried too quickly, may also split or develop other defects. Additionally, overdrying incurs unnecessary energy costs. Accurate lumber moisture content information also allows kiln operators to: adjust the kiln schedule according to drying needs; shut down the kiln when the lumber reaches a specified condition; and perform zone control.

One method of measuring and monitoring lumber moisture content involves contacting the lumber with a pair of electrodes and calculating the impedance or resistance of the wood (which varies with the moisture content) using a moisture detection circuit. This can be done, for example, with a handheld meter that has two pins that serve as electrodes. Another type of meter features metal plates which are placed very close to the wood. One example of a moisture detection circuit is described in Wagner, “Moisture Detection Circuit,” U.S. Pat. No. 5,486,815, which is incorporated herein by reference.

In-the-kiln instrumentation automates obtaining moisture content readings, thus saving manpower and time. Sensors (electrodes) are placed in constant contact with (or very near to) the wood while it is in the kiln, and the measurements are sent to a computer outside of the kiln.

However, in-the-kiln instrumentation must withstand the extreme environment of the kiln. Temperatures in kilns may vary widely, ranging from about 70 degrees to 300 degrees Fahrenheit. This temperature fluctuation complicates the electronic measurement of moisture content because the properties of electronic components change or “drift” as the temperature changes. For example, the base-emitter voltage of a transistor may decrease as the operating environment temperature increases, thus affecting the precision of analog circuits.

Additional impedances introduced by the measuring system complicate obtaining an accurate reading. For example, cables used to connect probes to a reader have a given capacitance which must be taken into account. This is complicated by the fact that cable capacitance is partially a function of cable length; thus cables of different lengths can have different capacitances.

It is common for a moisture sensor circuit to be tuned after installation. This typically involves simultaneously adjusting the zero offset and the gain of the circuit. In some systems the zero offset and gain are each controlled by a potentiometer, and a human being uses the potentiometers to adjust the circuit against a known, stable impedance. This process may require several iterations before the sensor is tuned.

### SUMMARY

An in-kiln moisture measurement system described herein uses in-kiln measurement electronics to produce moisture content readings virtually unaffected by temperature variations. The system comprises a personal computer which receives data from a per kiln unit (PKU). The PKU may be mounted above the kiln, on the outfeed side, for example. The PKU features one or more probe boards, which contain electronics for receiving signals from a sending unit. The sending unit receives signals from probes that are in contact with wood in the kiln.

The sending unit contains a circuit comprised of redundant half-circuits that compensate for the effects of temperature variations in the electronic components, including cables. One half-circuit acts as a moisture detector, and the other acts as a reference circuit. The two largely identical half-circuits each have matched transistor pairs, which ensure that the circuit readings drift by the same amount and in the same direction when exposed to temperature changes.

The moisture detector half-circuit reads a signal from the probes. The load of the reference half-circuit comes from a fixed reference capacitor. The reference capacitor is chosen for its low susceptibility to temperature drift. Signals generated by each half-circuit are sent to the PKU and processed in the probe board. Redundant circuitry is also found in the probe board. Calibration of the system to moisture content is then accomplished through software.

The system may be tuned using an Automatic Tuning Unit (ATU). The ATU attaches to a sending unit inside the kiln and interacts with the PKU to adjust the zero offset and gain of the system. This allows the system to provide normalized sensor value output.

### BRIEF DESCRIPTION OF THE DRAWINGS

FIG. 1A provides an overview of a moisture measuring system, depicting components inside a kiln.

FIG. 1B provides an overview of a moisture measuring system, depicting components both inside and outside the kiln.

FIG. 2 shows a schematic diagram of circuitry inside the sending unit.

FIG. 3 is a block diagram of a probe board contained within the PKU.

FIGS. 4A and 4B show a schematic diagram of probe board circuitry.

FIG. 5 shows an exemplary embodiment of a handheld Automatic Tuning Unit.

FIG. 6 shows a block diagram of the main circuit of an Automatic Tuning Unit.

FIG. 7 shows a schematic diagram of a relay driver circuit.

FIG. 8 shows a schematic diagram of a detector circuit.

FIG. 9 shows a schematic diagram of a transmitter circuit.

FIG. 10 shows a flowchart diagram of the automatic tuning process.

### DETAILED DESCRIPTION

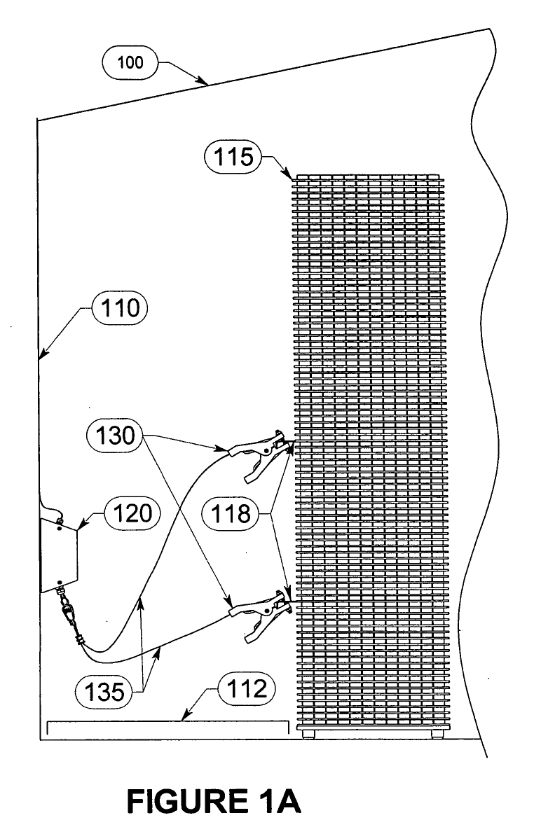

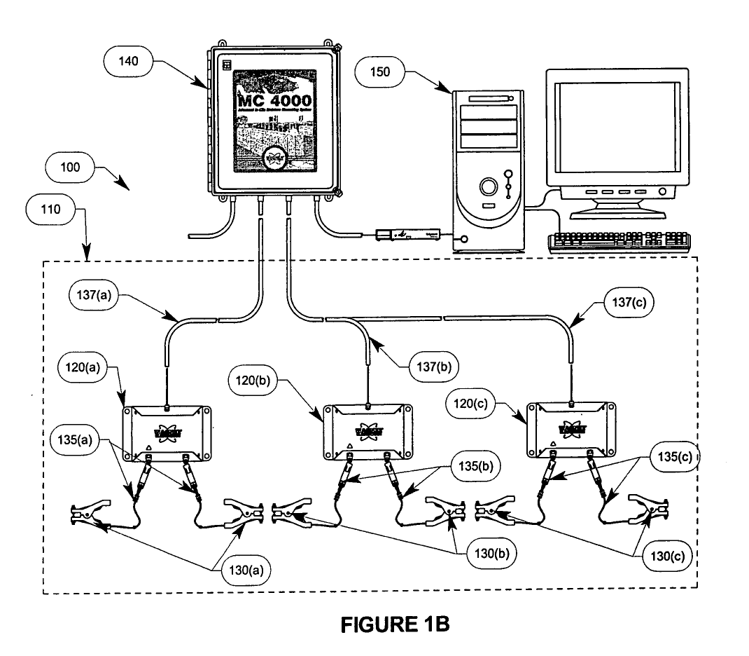

One embodiment of a moisture measuring system 100 is shown in FIG. 1A. This figure depicts the partial interior of a kiln 110, including the system components inside the kiln 110. A stickered lumber unit 115 sits inside the kiln 110. Probe strips 118, preferably made of stainless steel, are in contact with wood of the stickered lumber unit 115. Attached to the probe strips 118 are probe clamps 130. Mounted on the wall of the kiln 110 is a sending unit 120, and the probe clamps 130 are connected to the sending unit 120 through wires 135. The wires 135 may attach to the sending unit 120 through studs (not shown) on the sending unit 120. These can allow for the wires 135 to detach easily from the sending unit 120 if, for example, a piece of lumber or other object falls on the wires 135. The components inside the kiln 110 are made of materials that can withstand the extreme temperatures (up to 300 degrees F.) that occur during the kiln's operation. A number of suitable materials exist, but by way of example, the probe clamps 130 may have a body of heavy duty stainless steel or aluminum, and a stainless steel spring and teeth; the sending units 120 may be housed in containers made of 16 gauge stainless steel; and the wires 135 may also be made of stainless steel. The kiln 110 may feature a walkway 112 to allow for easy access to the lumber unit 115 or the sending unit 120.

A fuller view of the components of the moisture measuring system 100 is shown in FIG. 1B. In this figure the kiln 110 is represented by a broken line. If desired, the kiln 110 can include multiple sending units 120(a-c), each with corresponding wires 135(a-c), probe clamps 130(a-c) and probe strips 118 (not shown in this view).

Components outside the kiln 110 can include a per kiln unit (PKU) 140 which is connected to a computer 150, possibly via an RS-422 serial port. Signals travel between the PKU 140 and the sending units 120 via sensor cables 137(a-c). The sensor cables 137 may be protected while in the kiln 110 by conduits or protective channels. The computer 150 can execute software for analyzing or storing data recorded inside the kiln 110. The system 100 may also include means, such as an alarm and a relay, for shutting down the kiln 110 upon satisfying certain conditions, for example, when lumber drying in the kiln 110 reaches a specified moisture content level.

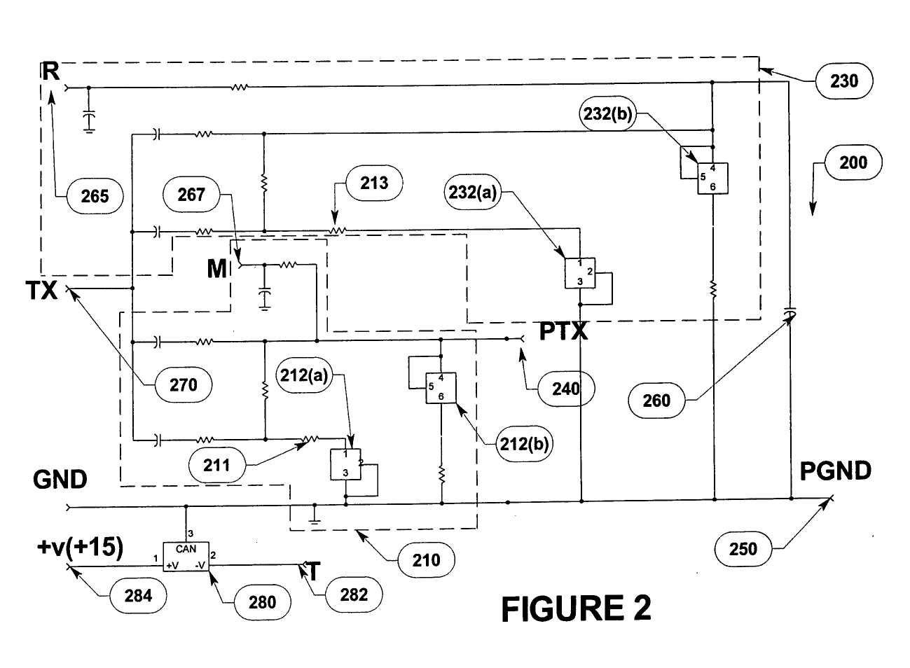

FIG. 2 depicts a circuit 200 found in each sending unit 120. The circuit 200 comprises two half-circuits 210 and 230 which are more or less identical. These identical halves allow for measuring the moisture in the wood in the kiln 110 while compensating for temperature-induced instability of electronic parts in the circuit 200. Half-circuit 210 serves as a moisture detector (by measuring the impedance of the wood), while half-circuit 230 aids in compensating for temperature-induced drift in half-circuit 210 (by measuring a fixed capacitance). Each half-circuit 210 and 230 features dual transistors, 212(a-b) and 232(a-b), respectively. The dual transistors 212 and 232 are “matched pairs,” i.e., the individual transistors have very nearly the same electrical properties. Ideally, each pair of transistors 212 and 232 is in a solitary package, which helps ensure that the transistors are matched. Generally uniform properties among the transistors 212 and 232 ensure that when the transistors drift due to changes in temperature, the half-circuits both drift in the same direction and by the same amount. Each transistor opposes and negates the temperature-induced drift of the other transistor in the pair. This arrangement also helps cancel drift in the wires 135, as well. The dual transistors 212 and 232 are selected in part for their ability to withstand the high temperatures of the kiln 110. Each transistor 212 and 232 is wired with its base tied to its collector, allowing the transistor to function as a diode.

The load for the half-circuit 210 is the signal PTX 240, which is provided by one of the probe strips 118 contacting wood inside the kiln 110. Half-circuit 210 measures the moisture content of the wood using PTX 240 and the signal PGND 250, which serves as a ground signal for the circuit 200 and is also provided by a probe strip 118. The load for half-circuit 230 is provided by a reference capacitor 260. This capacitor is selected for its electrical stability over a given temperature range, allowing it to provide a consistent capacitive load during operation of the kiln 110. In one embodiment, resistor 211 is of a smaller value than the corresponding resistor 213. This helps ensure that half-circuit 210 drifts the same amount as half-circuit 230 (which has the capacitive load). Both half-circuits 210 and 230 are fed by the signal TX 270, which is provided by the PKU 140. TX 270 is an AC signal that gives the circuit 200 an inherent potential through excitation. TX 270 may vary in amplitude and frequency, but in one embodiment the signal has a frequency of 1 MHz and an amplitude of about 18 V. Analog DC signals R 265 (a reference signal) and M 267 (a response to moisture content in the wood) are sent to the PKU 140 for processing. While both R 265 and M 267 change with temperature, the nature of the circuit 200 ensures that they drift in the same direction and at about the same rate.

Another element of the circuit 200 is a temperature sensor 280. In one embodiment the sensor 280 is a current-loop-type sensor where the output current T 282 is proportional to the temperature of its case. Supply voltage +V 284 (in one embodiment, about 15 V) is provided by the PKU 140.

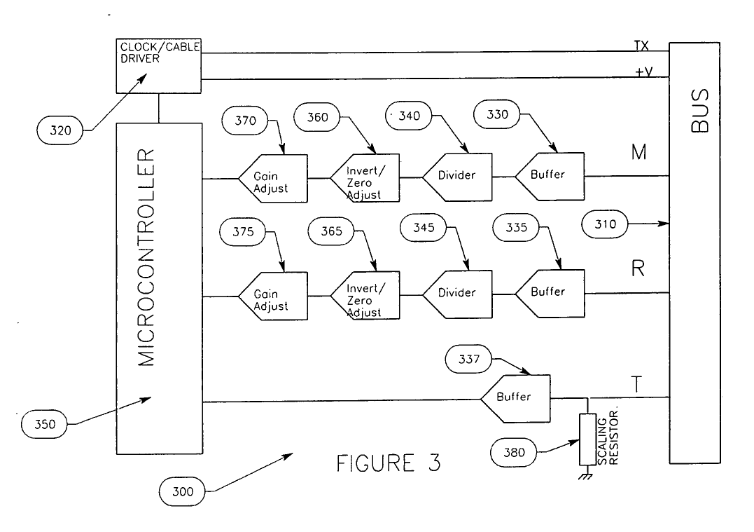

FIG. 3 depicts a block diagram of a probe board 300. The probe board 300 contains circuitry for processing signals from the sending unit 120. One or more probe boards 300 are contained within the PKU 140. Through a bus 310, signals TX 270 and +V 284 travel to the sending unit circuit 200, and signals M 267, R 265 and T 282 are received from the sending unit circuit 200. Signals TX 270 and +V 284 are generated by clock and cable driver circuitry 320. Signals from the sending unit circuit 200 are fed into buffers 330, 335 and 337 which eliminate coupling artifacts. The probe board 300 is further comprised of: divider circuits 340 and 345; a microcontroller 350; inverter circuits 360 and 365 with zero adjust; gain adjust circuits 370 and 375; and a scaling resistor 380.

Signals obtained by the sending unit circuit 200 are processed in the probe board 300 using the microcontroller 350. The microcontroller 350 may be one such as the PIC16C773 from Microchip Technologies, Inc., which includes a 12-bit A/D converter. After digitizing signals M 267 and R 265, the microcontroller 350 can calculate the difference between them.

As seen in FIG. 3, the principle of redundancy is also applied in the probe board 300, where M 267 and R 265 are processed in a similar manner. This helps compensate for temperature drift in the probe board 300. M 267 enters a buffer 330, which has a very high input impedance. This allows M 267 to be sampled without disturbing it. M 267 then enters a voltage divider circuit 340. Because the amplitude of M 267 varies with the length of the wire 135, it is useful to be able to adjust M 267 by means of the voltage divider 340. M 267 enters an inverting unity gain amplifier 360 with zero adjust. A higher moisture content in the lumber causes a weaker signal M 267. Inverting M 267 means that the amplitude of inverted M 267 increases as the moisture content increases. Before entering the microcontroller 350, M 267 also passes through a gain adjust amplifier 370, which is controlled by a digital potentiometer.

The signal R 265 travels a similar path in the probe board 300, passing through a buffer 335, a voltage divider 345, an inverting unity gain amplifier 365 with zero adjust, and a gain adjust amplifier 375, which is controlled by a digital potentiometer. T 282 is coupled to a scaling resistor 380 and passes through a buffer 337 before reaching the microcontroller 350.

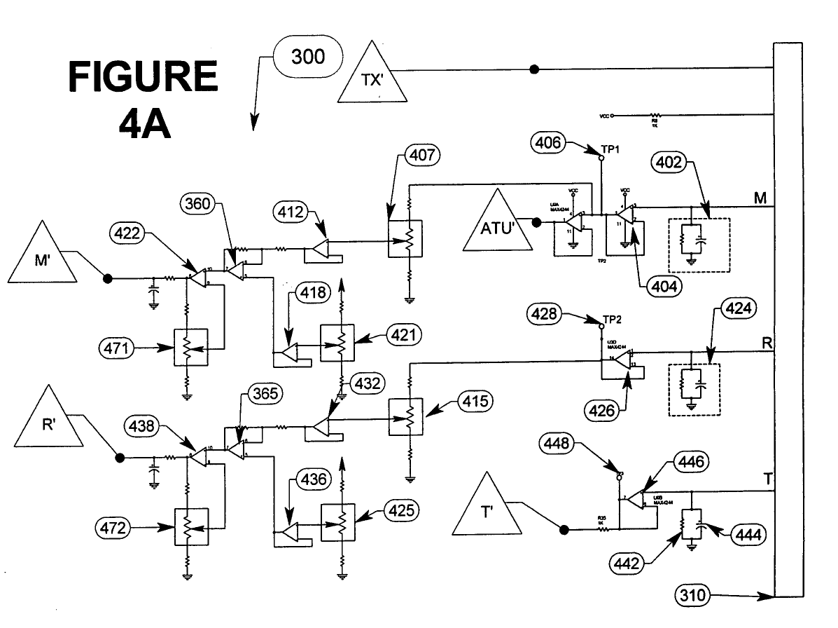

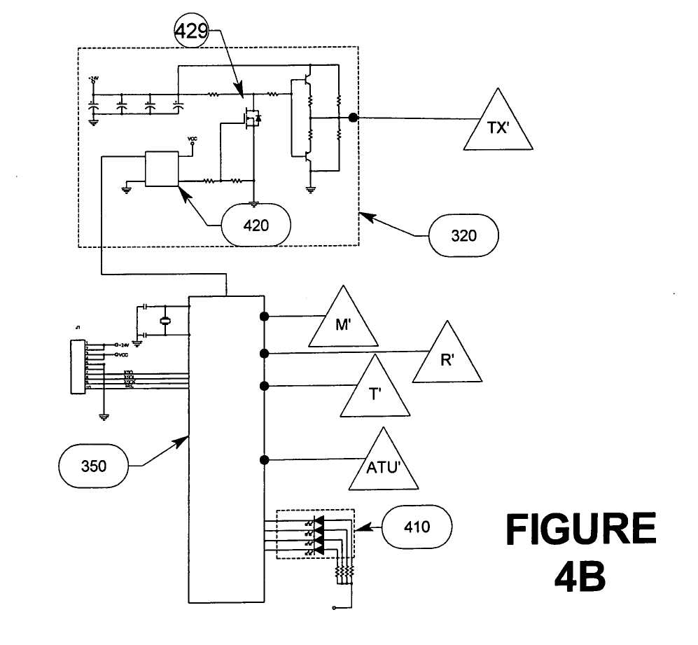

FIGS. 4A and 4B together display a detailed schematic of a possible implementation of the block diagram of FIG. 3. Signal connections that should be considered continuous between FIGS. 4A and 4B (e.g., M′) are indicated with a triangle and a signal name at the point of common connection. Signals M 267 and R 265 are coupled to filter circuits 402 and 424, respectively, possibly consisting of a capacitor and a resistor in parallel. The output current T 282 is coupled to a voltage conversion resistor 442 and a filter capacitor 444. Buffers 330, 335 and 337 are implemented with op amps. Also shown in FIG. 4 are additional buffers 412 and 432 between the voltage divider and inverting amplifier stages. These isolate the signal processing stages of the circuit 300. M 267, R 265 and T 282 may be measured at ports 406, 428 and 448 respectively.

Voltage dividers 340 and 345 are implemented with digitally controlled potentiometers 407 and 415, respectively. The present embodiment uses digital potentiometers with 256 possible positions, which allow for a fine level of tuning. Although the connections are not shown in FIGS. 4A and 4B, the digital potentiometers in this embodiment are controlled by the microcontroller 350. Inverting amplifiers 360 and 365 are implemented with op amps. The zero adjust for each amplifier is comprised, respectively, of buffer 418 and digital potentiometer 421; and of buffer 436 and digital potentiometer 425. As the amplitudes of R 265 and M 267 are already adjusted by the voltage dividers, adjustments using the zero adjusts are generally very fine. Gain adjust amplifiers 370 and 375 are implemented, respectively, by op amp 422 and digital potentiometer 471; and by op amp 438 and digital potentiometer 472.

Additional features in FIG. 4B include diagnostic LEDs 410 a clock generator 420, and an amplifier transistor 429.

The system 100 may also be tuned, perhaps after it is installed, for example. The tuning process allows for normalization of a circuit 200 in one or more sending units 120, enabling the system 100 to provide normalized sensor value output. In this case, “normalization” means that, regardless of installation details such as cable length, and regardless of manufacturing details such as component value tolerances, the circuits 200 in various sending units 120 will return essentially the same reading when subjected to the same load of moisture. The tuning process allows for the output of the electronics of the system 100 (sometimes called the “overall gain” of the system) to be scaled such that this output can represent the entire possible range of moisture values. Additionally, the tuning process compensates for the “inherent gain” of the system 100, which may be influenced by capacitances in the cables 137 of FIG. 1, for example.

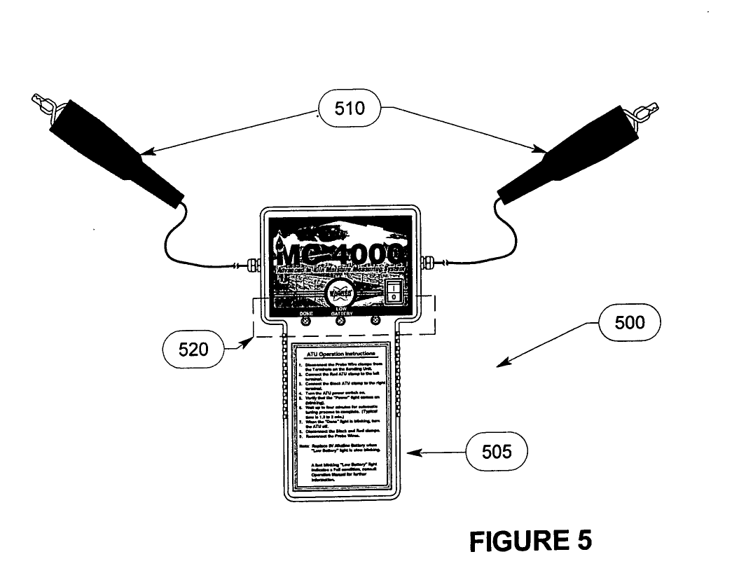

Tuning is carried out by means of an Automatic Tuning Unit (ATU) 500 shown in FIG. 5, which may be implemented as a device separate from any other element of the system 100, possibly as a handheld unit 505. The ATU 500 uses electrodes 510 to attach to studs (not shown) on a sending unit 120. This allows the ATU 500 to communicate with the probe board 300 in the PKU 140. It may also feature a set of status indicators 520.

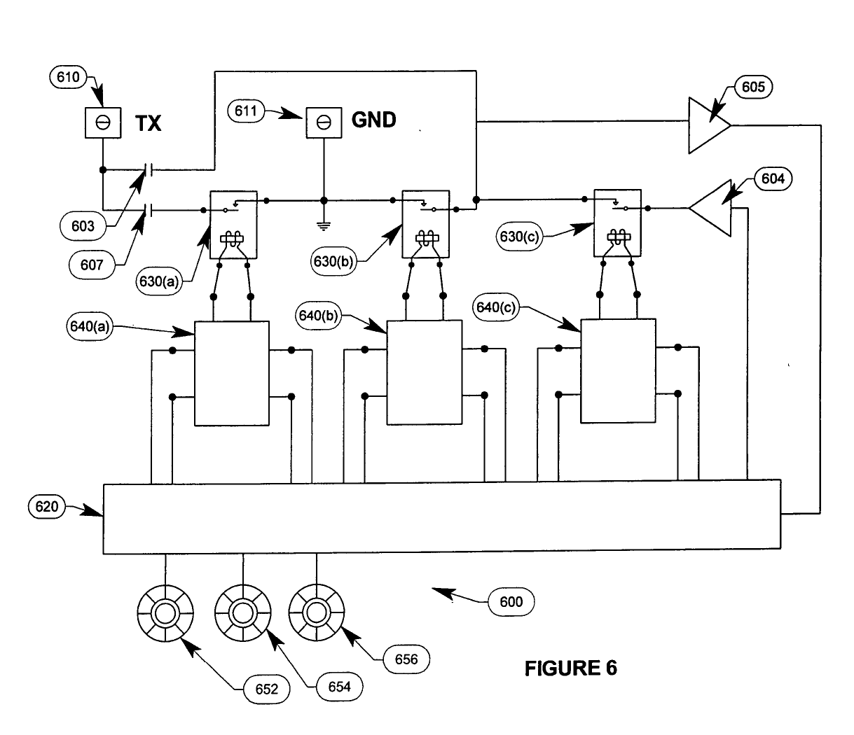

FIG. 6 depicts the main circuit 600 of the ATU 500. A microcontroller 620 controls three relay driver circuits 640(a-c), which in turn control relays 630(a-c). A low-impedance load is provided by capacitor 603, and a high impedance load is provided by capacitor 607. Sample values for these capacitors may be 82 pF and 270 pF, respectively. The difference between the high impedance load and the low impedance load is knows as the “span.” Capacitors 603 and 607 are selected in part for their accurate tolerances and their temperature stability. The main circuit 600 is electrically connected to the sending unit 120 through TX 610 and GND 611, which are physically attached to the sending unit 120 through electrodes 510. A transmitter circuit 604 and a detector circuit 605 allow the ATU 500 to communicate with the probe board 300. In one embodiment, the status indicators 520 are comprised of LEDs and include a done indicator 652, a battery low indicator 654, and a power indicator 656.

Via the relay driver circuits 640(a-c) (working with their corresponding relays 630(a-c), respectively), the microcontroller 620 controls the input and output of the main circuit 600. For example, the microcontroller 620 uses relay 630(a) and relay driver circuit 640(a) to switch to the high-impedance load provided by capacitor 607; or, it uses relay 630(b) and relay driver circuit 640(b) to switch to the low-impedance load provided by capacitor 603. The microcontroller 620 activates relay control circuit 640(c) and relay 630(c) to connect the transmitter circuit 604 to the sending unit circuit 200. Control circuit 640(c) is usually not activated unless the ATU 500 is sending a message to the probe board 300.

The detector circuit 605 allows the ATU 500 to receive messages from the probe board 300. In one embodiment, the detector circuit 605 outputs a voltage level corresponding to a logic ‘1’ or ‘0’ whenever the probe board 300 sends a signal through TX 610. This voltage is converted to a logic level in the microcontroller 620, which may contain an integrated A/D-converter. The microcontroller 620 may be programmed to recognize a signal longer than a predetermined length and assume that the long signal is not part of a message. By accumulating I's and O's, the ATU 500 can decipher various commands. A similar detector is employed in the probe board 300 to detect messages from the ATU 500.

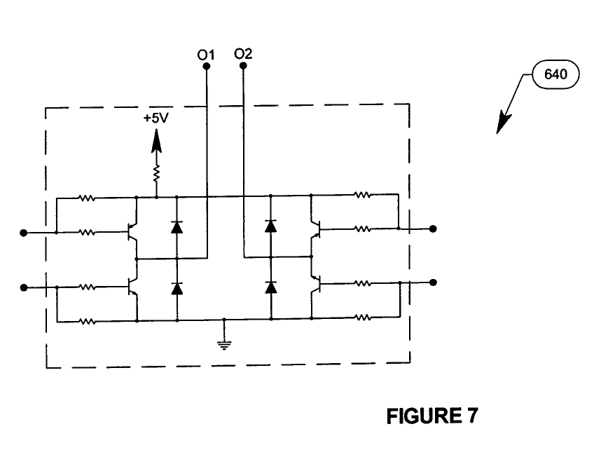

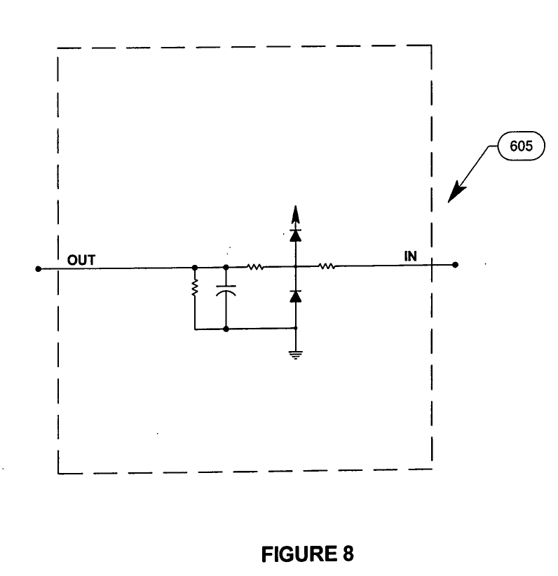

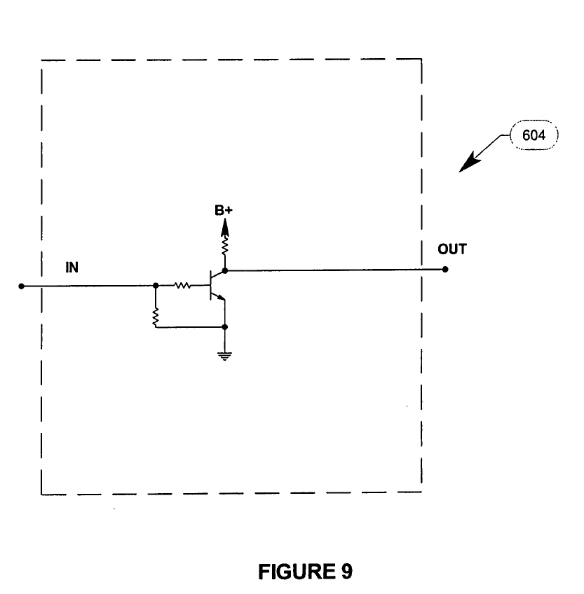

FIG. 7 shows a schematic diagram of a relay driver circuit 640. FIG. 8 shows a schematic diagram of a detector circuit 605. FIG. 9 shows a schematic diagram of a transmitter circuit 604.

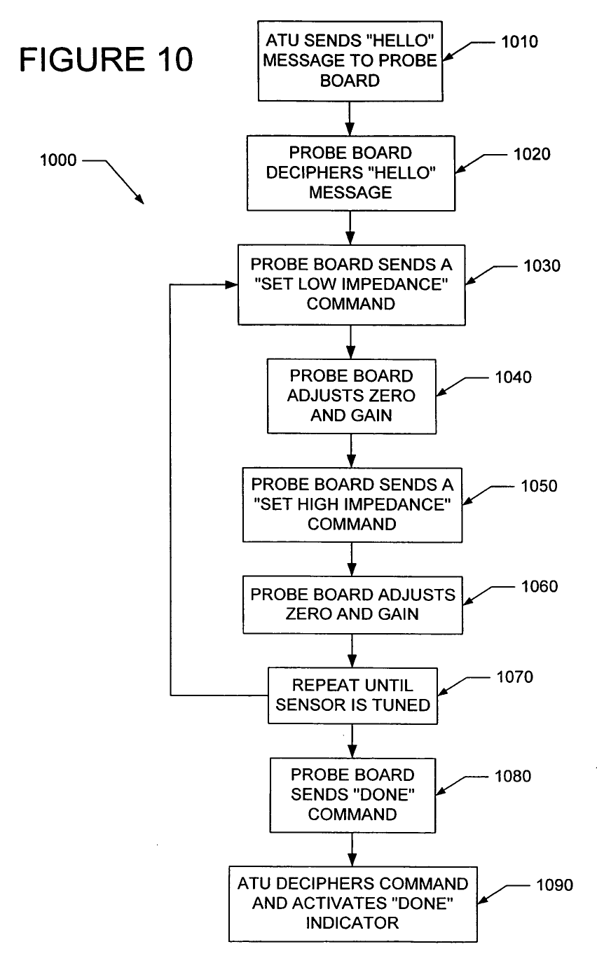

A flowchart of the automatic tuning process 1000 appears in FIG. 10. Step 1010, in which the ATU 500 sends a “hello” message (i.e., a signal or code signifying initial contact) to the probe board 300, occurs after the ATU 500 is connected to the sending unit 120 and turned on. In step 1020, the probe board 300 deciphers the “hello” message and then sends a “set low impedance” command (step 1030). Accordingly, the main circuit 600 uses relay 630(b), relay driver circuit 640(b) and microcontroller 620 to switch to the low-impedance load provided by capacitor 603. With this low-impedance load on the sending unit 120, in step 1040 the probe board 300 adjusts the zero and gain of elements in the probe board 300 using digital potentiometers, for example. For example, inverter circuits 360 and 365 and gain adjust circuits 370 and 375 of FIG. 3 may be adjusted according to a predetermined specification. In step 1050, the probe board 300 sends a “set high impedance” command to the ATU 500. The main circuit 600 uses relay 630(a), relay driver circuit 640(a) and microcontroller 620 to switch to the high-impedance load provided by capacitor 607. With a high-impedance load on the sending unit 120, in step 1060 the probe board 300 again adjusts the zero and gain of elements in the probe board 300. Steps 1030 through 1060 are repeated (step 1070) until the system 100 is tuned within a desired set of parameters. At this point, the probe board 300 sends a “done” command to the ATU 500 (step 1080). The ATU 500 then activates the done indicator 652 (step 1090).

The communications protocol used by the probe board 300 and the ATU 500 may include a means by which the ATU 500 echoes back to the probe board 300 a command that the ATU 500 receives. This allows the probe board 300 to confirm that a command has been received and executed. The protocol may also include a means for the probe board 300 to determine that the ATU 500 is not functioning properly or that an error has occurred. A message indicating such a state may be sent from the PKU 140 to the computer 150, which may notify a human operator of the malfunction. The error condition may also be indicated using the diagnostic LEDs 410 of the probe board 300 shown in FIG. 4B. One of the LEDs 410 may be dedicated to indicating that the system 100 is properly tuned. Additionally, the protocol may include means by which the ATU 500 may determine that an error has occurred. For example, if the ATU 500 does not receive a message from the probe board 300 within a predetermined time interval, the ATU 500 will indicate an error status, possibly by displaying a blinking pattern on the battery low indicator 654.

The process 1000 allows the moisture response curve of the circuit 200 to generally match a desired moisture response curve. Additionally, at the time of tuning, reference values for the signals R 265 and M 267 may be stored so that drift may later be accounted for by comparing present values with the reference values.

Once the system 100 has been calibrated to provide normalized sensor value output, calibration for moisture content in the wood can be accomplished by software, such as the MC4000 Software available from Wagner Electronic Products, Inc., running in the computer 150.

Having described and illustrated the principles of the system with reference to a preferred embodiment thereof, it will be apparent that the system can be modified in arrangement and detail without departing from such principles. In view of the many possible embodiments to which the principles of the system may be put, it should be recognized that the detailed embodiment is illustrative only and should not be taken as limiting the scope of the system. Accordingly, I claim as the invention all such modifications as may come within the scope and spirit of the following claims and equivalents thereto.

I claim:

1. A moisture measurement system, comprising:
electrodes in communication with wood inside a kiln; and
an electronic circuit inside the kiln, the electronic circuit comprising a first circuit half and a second circuit half;
wherein the first and second circuit halves are substantially similar, and wherein the first circuit half receives a load from an electrode in communication with the wood and the second circuit half receives a load from a reference element.

2. The system of claim 1, further comprising processing circuitry outside the kiln.

3. The system of claim 2, the processing circuitry comprising a microcontroller, a potentiometer, and an amplifier.

4. The system of claim 1, further comprising software for calibrating the system to moisture content.

5. The system of claim 1, wherein the reference element is a capacitor.

6. The system of claim 1, wherein the reference element features stable electrical properties over a given temperature range.

7. An electronic circuit for measuring moisture in wood, comprising:
a first circuit half featuring a first transistor pair; and
a second circuit half featuring a second transistor pair;
wherein the first and second circuit halves are substantially similar, and wherein the first circuit half receives a load from an electrode in communication with wood and the second circuit half receives a load from a reference element.

8. The electronic measurement circuit of claim 7, wherein transistors of the first transistor pair and transistors of the second transistor pair feature approximately the same electrical properties.

9. The electronic measurement circuit of claim 7, wherein the reference element is a capacitor.

10. The electronic measurement circuit of claim 9, wherein the capacitor features stable electrical properties over a given temperature range.

11. The electronic measurement circuit of claim 7, further comprising a temperature sensor.

12. A method of compensating for temperature-induced drift in a wood moisture-measurement circuit, the method comprising:
using a first circuit half to measure an impedance through electrodes in communication with wood; and
using a second circuit half to measure the impedance of a reference load.

13. The method of claim 12, further comprising calculating the difference between the impedance measured with the first circuit half and the impedance measured with the second circuit half.

14. The method of claim 12, further comprising creating an inherent potential through excitation of the first circuit half and the second circuit half.

15. The method of claim 12, wherein the reference load is a capacitor.
